(19) United States
(12) Patent Application Publication
(10) Pub. No.: US 2025/0086587 A1
(43) Pub. Date: Mar. 13, 2025

(54) ENHANCED CONTACT LIST GENERATION AND TRACKING

(71) Applicant: Arven Group LLC, Houston, TX (US)

(72) Inventor: Rachel WILSON, Houston, TX (US)

(73) Assignee: Arven Group LLC, Houston, TX (US)

(21) Appl. No.: 18/829,154

(22) Filed: Sep. 9, 2024

Related U.S. Application Data
(60) Provisional application No. 63/537,097, filed on Sep. 7, 2023.

(51) Int. Cl. G06Q 10/10; H04L 51/04

(52) U.S. Cl. CPC G06Q 10/10; H04L 51/04

(57) ABSTRACT

A contact list management system may receive user information associated with a user and contact profile information associated with a set of contacts. The contact list management system may determine, using a machine learning model and based on the user information and the contact profile information, confidence scores corresponding to contacts included in the set of contacts. The confidence scores may indicate a likelihood of a future contribution to the user by contacts included in the set of contacts. The contact list management system may generate, based on the confidence scores, a contact list including a set of prioritized contacts. The contact list management system may provide the contact list.

### CROSS-REFERENCE TO RELATED APPLICATION

This application claims the benefit of U.S. Provisional Application No. 63/537,097, filed Sep. 7, 2023, which is incorporated herein by reference in its entirety.

### BACKGROUND

Contact list management systems are commonly used to facilitate organization, storage, and retrieval of contact information for individuals and entities across various domains (e.g., by generating and maintaining up-to-date contact lists by gathering relevant contact data. Once the contact data is collected, the contact list management systems can generate contact lists tailored to specific criteria, which can be used in marketing, sales, fundraising, and other outreach efforts.

### SUMMARY

Some implementations described herein relate to a system, including: one or more memories; and one or more processors, communicatively coupled to the one or more memories, configured to: receive user information associated with a user; receive contact profile information associated with a set of contacts, determine, using a machine learning model and based on the user information and the contact profile information, confidence scores corresponding to contacts included in the set of contacts, wherein the confidence scores indicate a likelihood of a future contribution to the user by contacts included in the set of contacts; generate, based on the confidence scores, a contact list including a set of prioritized contacts; and provide the contact list.

Some implementations described herein relate to a method, including: receiving, by a contact list management system, user information associated with a user; receiving, by the contact list management system, contact profile information associated with a set of contacts, determining, by the contact list management system and using a machine learning model, confidence scores based on the user information and the contact profile information, wherein the confidence scores correspond to contacts included in the set of contacts, and wherein the confidence scores indicate a likelihood of a future contribution to the user by the contacts included in the set of contacts; generating, by the contact list management system and based on the confidence scores, a contact list including a set of prioritized contacts; and providing, by the contact list management system, the contact list.

Some implementations described herein relate to a non-transitory computer-readable medium storing a set of instructions, the set of instructions including: one or more instructions that, when executed by one or more processors of a contact list management system, cause the contact list management system to: receive user information associated with a user; receive contact profile information associated with a set of contacts, determine, using a machine learning model and based on the user information and the contact profile information, confidence scores corresponding to contacts included in the set of contacts, wherein the confidence scores indicate a likelihood of a future contribution to the user by contacts included in the set of contacts; generate, based on the confidence scores, a contact list including a set of prioritized contacts; and provide the contact list.

### BRIEF DESCRIPTION OF THE DRAWINGS

FIGS. 1A-1B are diagrams of an example associated with enhanced contact list generation and tracking, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with enhanced contact list generation and tracking, in accordance with some embodiments of the present disclosure.

FIG. 4 is a flowchart of an example process associated with enhanced contact list generation and tracking, in accordance with some embodiments of the present disclosure.

### DETAILED DESCRIPTION OF EXAMPLE EMBODIMENTS

The following detailed description of example implementations refers to the accompanying drawings. The same reference numbers in different drawings may identify the same or similar elements.

A contact list management system may be used to generate and/or maintain a contact list. For example, the contact list management system may obtain contact list data (e.g., associated with individuals and/or entities). The contact list management system may store the contact list data in a database and may generate a contact list based on the contact list data.

However, typical contact list management systems are prone to storing inaccurate and/or stale (e.g., outdated) contact list data, such as inaccurate and/or stale phone numbers, email addresses, and/or physical locations associated with the individuals and/or entities. As a result, if the contact list management system uses the inaccurate and/or stale contact list data to communicate (e.g., with a device associated with the individual and/or the entity), then the contact list management system may waste resources (e.g., processing resources, memory resources, and/or network resources) associated with failed communications (e.g., based on the inaccurate and/or the stale data).

Additionally, typical contact list management systems often store duplicate contact list data (e.g., based on data entry errors, system migrations, and/or merging of databases). Managing duplicate contact list data consumes resources, skews analytics, and can lead to inconsistent communications (e.g., between the contact list management system and a device associated with the individual and/or the entity). Furthermore, typical contact list management systems employ inadequate security techniques. For example, typical contact list management systems share the contact list data with a third-party device (e.g., associated with an individual or entity) without protection (e.g., without being encrypted or otherwise protected). As a result, the contact list data may be subject to unauthorized access and/or tampering, which can lead to a malicious actor obtaining unauthorized access to the contact list data and/or performing unauthorized modifications to the contact list data.

Some implementations described herein provide enhanced contact list generation and tracking. For example, a contact list management system may obtain user information, contact profile information (e.g., information associated with one or more profiles of contacts, one or more individuals, and/or one or more entities, among other examples), donor information, prospective donor information, and/or customer information, among other examples. As an example, the contact list management system may analyze the user information, the donor information, the contact information, the prospective donor information, and/or the customer information, among other examples, to obtain contact list information. The contact list management system may generate a contact list based on the contact list information, as described in more detail elsewhere herein.

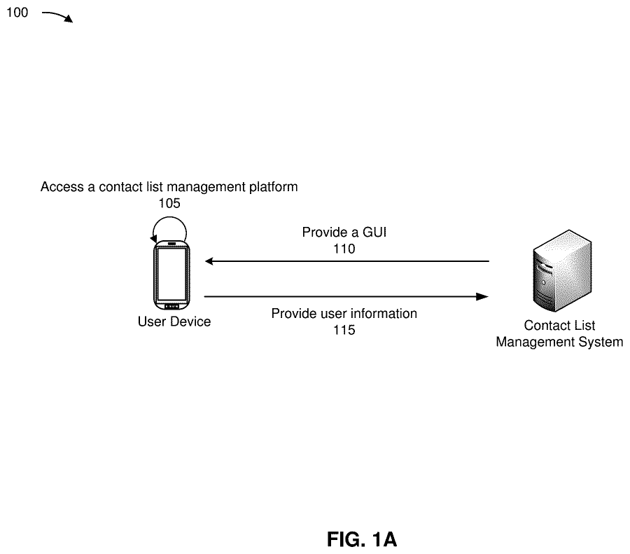

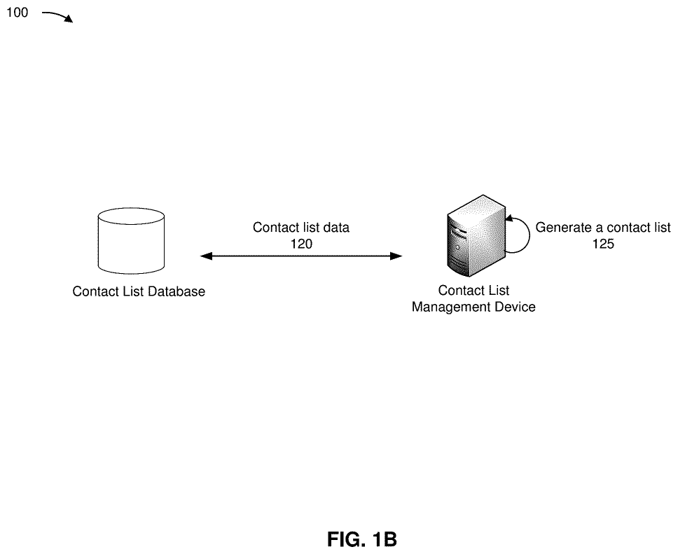

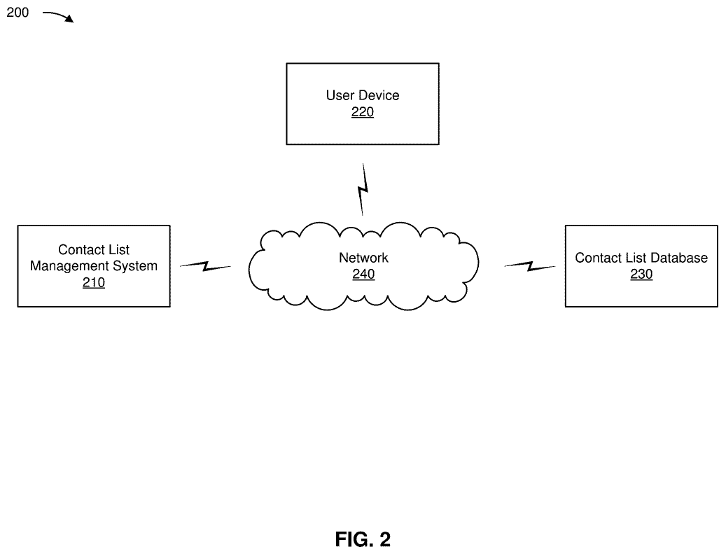

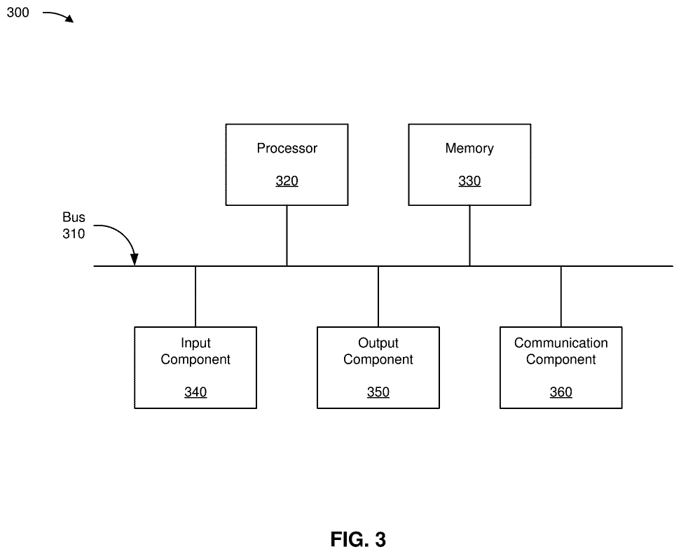

FIGS. 1A-1B are diagrams of an example 100 associated with enhanced contact list generation and tracking. As shown in FIGS. 1A-1B, example 100 includes a contact list management system, a user device, and a contact list database. These devices are described in more detail in connection with FIGS. 2 and 3.

As shown in FIG. 1A, and by reference number 105, a user may utilize a user device to access a contact list management platform. In some implementations, the contact list management platform may be associated with an application. For example, the contact list management platform may be a web-based application, which can be accessed via a web browser executing on the user device. As another example, the contact list management platform may be a mobile application, or a native application, executing on the user device, which can be accessed by the user via a user interface of the user device.

As further shown in FIG. 1A, and by reference number 110, the contact list management system may provide a graphical user interface (GUI) for display via the user device. For example, the contact list management system may provide the GUI for display, via the user device, in response to the user performing a login operation associated with the application (e.g., the user may initiate an authentication process by inputting, via the user interface of the user device, an email address and a password associated with the user and the application, among other examples).

In some implementations, the GUI may include one or more fields associated with inputting user information related to the user. For example, the user information may include endorsement information (e.g., a political endorsement), ideology information (e.g., a political ideology), personal interest information (e.g., a hobby), educational background information (e.g., an educational institution degree), industry of expertise information (e.g., education, entertainment, and/or legal expertise), military experience information (e.g., a branch of service and/or a rank), professional background information (e.g., employer and/or employment status), and/or historical interaction information (e.g., historical dates and/or locations associated with dates and/or locations of a work schedule and/or a personal schedule of the user), among other examples.

As further shown in FIG. 1A, and by reference number 115, the user device may provide, and the contact list management system may receive, the user information. For example, the user device may provide (e.g., via the user interacting with the user interface of the user device) the user information as an input into the one or more fields provided via the GUI.

As shown in FIG. 1B, and by reference number 120, the contact list management system may receive, from a contact list database, contact list data. As an example, the contact list management system may obtain the contact list data, from the contact list database, in response to receiving the user information that is input, via the user device, into the GUI. In some implementations, a server device associated with the contact list database may be used to obtain the contact list data. As an example, one or more websites (e.g., publicly available websites) may provide the contact list data for viewing (e.g., by a user of the website). The server device may navigate through the one or more websites to extract the contact list data from the one or more websites. The server device may send, and the contact list database may receive, the contact list data for storage by the contact list database. Although the contact list data is described as being obtained via the server device associated with the contact list database, the contact list data may be obtained in any suitable manner.

As further shown in FIG. 1B, the contact list management system may generate a contact list. For example, the contact list management system may generate the contact list based on the user information and/or the contact list data. In some implementations, the contact list management system may classify and/or prioritize the information indicated by the user information and the contact list data. For example, the contact list management system may classify the user information and/or the contact list data into one or more categories and may assign a score to the user information and/or the contact list data in the one or more categories, as described in more detail elsewhere herein.

In some implementations, the user may be a candidate, such as a candidate seeking election for office, and the contact list data may be associated with donors (e.g., political donors) and/or prospective donors (e.g., prospective political donors). Accordingly, for example, the contact list data may include contact information associated with the donors and/or the prospective donors. As an example, the contact list data may include profile information, demographic information, interaction information (e.g., contributions and/or prospective contributions), biographical information, personal interest information e.g., (hobbies), philanthropical interaction information (e.g., philanthropical contributions and/or prospective philanthropical contributions), business interaction information (e.g., historical business interactions and/or prospective business interactions), event interaction information (e.g., historical event interactions and/or prospective event interactions)), business information (e.g., corporate board, business associate, and/or business interest information), alumni information (e.g., associated with an educational institution), and/or location information (e.g., geographic locations associated with an industry related to the candidate), among other examples.

As an example, if the user is a candidate seeking election for office, then the user information may indicate a party affiliation of the candidate (e.g., a political party affiliation), political race information (e.g., an electoral office sought by the candidate and/or competitor information associated with competitors running for the electoral office sought by the candidate), endorsements of the candidate, an election jurisdiction, campaign information (e.g., campaign overview, campaign message, campaign slogan, campaign promise, policy priorities, campaign activities, town hall meetings, grassroots canvassing, online fundraising events, policy forums and debates, and/or community service initiative information, among other examples), campaign challenges (e.g., incumbent competition and/or fiscal responsibility information), fundraising information (e.g., total contributions received, top contributors, geographic breakdown of contributions), and/or industries associated with the candidate (e.g., education and/or technology and innovation industries), among other examples.

As another example, if the contact list data is associated with donors (or other contacts) and/or prospective donors (e.g., or other prospective contacts), then the contact list data may indicate names, occupations or employers, geographical location information (e.g., a city and a state), historical political interactions (e.g., historical contributions, historical recipients of the historical contributions, and/or historical attendance of political events), and/or prospective political interactions (e.g., prospective contributions, prospective recipients of the prospective contributions, and/or prospective attendance of political events), among other examples.

Accordingly, for example, the contact list management system may generate the contact list based on the information associated with the candidate, the donors, and/or the prospective donors, as described in more detail elsewhere herein. In some implementations, to generate the contact list, the contact list management system may analyze the user information (e.g., the information associated with the candidate) and/or the contact list data (e.g., the information associated with the donors and/or the prospective donors) to obtain contact list information. Although the contact list management system is described as obtaining the contact list information by analyzing the user information and/or the contact list data, the contact list management system may obtain the contact list information in any suitable manner.

For example, the contact list information (e.g., obtained via the contact list management system analyzing the user information and/or the contact list data) may indicate information associated with donors who previously contributed to the candidate, amounts associated with the previous contributions (e.g., currency values associated with the previous contributions), dates and/or times associated with the previous contributions, geographic locations associated with the previous contributions, donors who previously contributed to endorsers of the candidate, donors who previously contributed to prospective (or target) endorsers of the candidate, business industry associates of the candidate, the donors, and/or the prospective donors (e.g., industry colleagues of the candidate, the donors and/or the prospective donors), donors who have business interests in a geographic location associated with the candidate, donors who previously attended events and/or who previously contributed to candidates who have similar interests to interests of the candidate (e.g., candidates who have similar campaign interests to the campaign interests of the candidate and/or candidates who have similar industry interests to the industry interests of the candidate), donors who previously contributed to candidates in similar contexts to contexts associated with the candidate (e.g., donors who previously contributed to candidates running for the same office sought by the candidate), political race information (e.g., indicating whether the candidate is in an open seat election or challenging an incumbent), and/or a competition level associated with the political race (e.g., whether the political race is an uncontested race, a low-competition race, a moderate-competition race, a highly-competitive race, and/or an incumbent versus a challenger race), among other examples.

In some implementations, the contact list management system may classify and/or prioritize the contact list information (e.g., into one or more categories, as described in more detail elsewhere herein). As an example, the contact list management system may classify the contact list information into a first category associated with donors who previously contributed to the candidate, a second category associated with donors who previously contributed to candidates that are similar to the candidate (e.g., as described in more detail elsewhere herein), and/or a third category associated with prospective donors.

In some implementations, the contact list management system may assign a score to the contact list information classified into the first category, the second category, and/or the third category. As an example, the contact list management system may determine a recency of the contributions of the donors classified into the first category. The contact list management system may assign the score to the donors based on the recency of the contributions. For example, if a first contribution (e.g., associated with a first donor referred to as donor A) is contributed at a first date that is closer in time to a current date than a second contribution (e.g., associated with a second donor referred to as donor B) contributed at a second date, then the contact list management system may assign a higher score to Donor A than Donor B.

In some implementations, the contact list management system may generate the contact list based on the first category, the second category, and/or the third category. As an example, fifty percent of the contact list (e.g., generated by the contact list management system) may include information associated with donors classified into the first category, twenty-five percent of the contact list may include information associated with donors classified into the second category, and twenty-five percent of the contact list may include information associated with donors classified into the third category. In other words, for example, fifty percent of the contact list may include information associated with donors who previously contributed to the candidate, twenty-five percent of the contact list may include information associated with donors who previously contributed to candidates that are similar to the candidate, and twenty-five percent of the contact list may include information associated with prospective donors.

As another example, the contact list management system may classify the contact list information into a single category associated with prospective donors, and the contact list management system may generate the contact list based on the single category. For example, the contact list (e.g., generated by the contact list management system) may include information associated with only prospective donors.

In some implementations, the one or more fields (e.g., of the GUI) may be associated with inputting a geographic location, a minimum contribution amount, and/or a maximum contribution amount associated with an event related to the candidate. As an example, the contact list management system may generate the contact list based on the user information, the contact list data, the geographic location, the minimum contribution amount, and/or the maximum contribution amount. For example, if the candidate is scheduled to attend a town hall meeting in Houston, Texas, and the candidate is interested in receiving contributions within a range of $50 to $2,000, then the candidate may provide, via the user interface of the user device, “Houston, Texas” as the geographic location input to the GUI, “$50” as the minimum contribution amount input to the GUI, and “$2,000” as the maximum contribution amount input to the GUI. The contact list (e.g., generated by the contact list management system), may include information associated with donors and/or prospective donors who reside within a threshold distance of Houston, Texas, and/or who previously provided, or may be willing to provide (e.g., a soft pledge has been made by a prospective donor), contributions between $50 and $2,000.

In some implementations, the contact list management system may communicate with a server device (e.g., a server device associated with the user and/or a server device associated with a third-party) to exchange information. As an example, the contact list management system may communicate with a server device of a third-party entity (e.g., via an application programming interface (API)), to obtain third-party contact list data from the server device. In some implementations, the server device may automatically send, and the contact list management system may receive, the third-party contact list data. In some implementations, the contact list management system may maintain the contact list data stored in the contact list database based on the third-party contact list data.

As another example, the contact list management system may communicate with a server device associated with the user to obtain user contact list data (e.g., stored by a user contact list database associated with the server device). For example, if the server device is associated with an existing officeholder, then the contact list management system may communicate with the server device to integrate user contact list data stored in a user contact list database with the contact list data stored in the contact list database.

In some implementations, the contact list management system may generate the contact list based on the contact list data and the user contact list data. For example, the contact list management system may add information to the contact list (e.g., if the contact list data includes information that the user contact list data does not include) and/or may remove information from the contact list (e.g., if the contact list data and the user contact list data include duplicate information).

Additionally, or alternatively, the contact list management system may integrate with various databases and/or donation platforms (e.g., by communicating with associated server devices of the various databases and/or donation platforms). As an example, the contact list management device may integrate with the various databases and/or donation platforms to track contact list data, as described in more detail elsewhere herein.

In some implementations, the contact list management system may provide the contact list for display via the GUI, as described in more detail elsewhere herein. For example, the contact list management system may provide the contact list information via a read-only format and/or may obfuscate information indicated by the contact list. In this way, the contact list may not be changed and/or may be obfuscated to protect the contact information associated with the donor. For example, the contact list management system may obfuscate the contact information associated with a donor to generate obfuscated contact information associated with the donor.

In some implementations, the GUI may include a create profile feature associated with enabling the donors to create a donor profile that includes one or more donor preferences related to the contact list information. For example, the one or more preferences may indicate that the donor may be contacted via a particular communication channel, that the donor may be contacted via a business phone number rather than a personal phone number, and/or that the donor opts in or opts out of having their information displayed via the GUI). Accordingly, in some implementations, the contact list management system may provide the GUI for display via a user device associated with a donor, and the donor may provide information associated with the one or more preferences via the create profile feature of the GUI.

As an example, if the contact information indicates a phone number, an email address, and/or an address of the donor, then the contact list management system may generate an altered phone number, an altered email address, and/or an altered address associated with the donor. In this way, the contact list presented to the user via the user device may present the obfuscated contact information. In other words, for example, the user does not have access to the phone number, email address, and the address of the donor.

In some implementations, the contact list management system may enable the user to view the phone number, email address, and/or the address associated with the donor. For example, if the contact list management system determines that the donor contributes to the candidate, then the contact list management system may present the phone number, the email address, and/or the address associated with the donor for display to the user via the user device. In other words, for example, the user has access to the contact information associated with the donor only if the donor contributes to the user.

In some implementations, the GUI may include one or more contact list operations. As an example, the contact list management system may include a first contact list operation (e.g., a call operation), a second contact list operation (e.g., a text message operation), and/or a third contact list operation (e.g., an email operation). The contact list management system may perform the one or more contact list operations based on a user input indicating the one or more contact list operations. As an example, the user may provide, via the user interface of the user device, a user input indicating a call operation associated with a donor indicated by the contact list. The contact list management system may perform the call operation based on the user input. As an example, the contact list management system may cause a phone call to be placed to the donor associated with the user input.

In some implementations, the GUI may include a result input (e.g., a contact list operation result input) associated with a result of the contact list operation. For example, if the user selects the call operation, then the user may provide, via the user interface of the user device, the result input based on the call operation. For example, the result input may indicate that a message was left for the donor (e.g., in a voicemail box) or that the donor was reached. As an example, if the donor was reached, then the result input may indicate that the donor agreed to a hard pledge (e.g., and any related contribution amounts associated with the hard pledge), that the donor agreed to a soft pledge (e.g., and any related contribution amounts), that the donor offered to host an event, that the donor requested a meeting with the candidate, that the donor contributed (e.g., based on the call operation), that the donor declined to contribute, that the donor was not able to be reached (e.g., based on an incorrect phone number), and/or that the donor does not have voicemail capability, among other examples). In this way, the contact list management system may track the contact list information in real-time (e.g., to enable the contact list to be maintained and/or updated, among other examples).

In some implementations, the user may provide, via the user interface of the user device, a user input indicating a text message operation associated with a donor indicated by the contact list. The contact list management system may perform the text message operation based on the user input. As an example, the contact list management system may cause a follow up text message to be sent to the donor. The contact list management system may maintain a text message log that displays the altered phone numbers associated with the donors. If a donor contributes to the user, then the contact list management system may display the phone number associated with the donor that contributes rather than the altered phone number associated with the donor that contributes.

In some implementations, the user may provide, via the user interface of the user device, a user input indicating an email operation associated with a donor indicated by the contact list. As an example, the user may provide the user input based on a result input (e.g., based on a message left for the donor, a pledge indicated by the donor, an information request indicated by the donor, an event associated with the donor, and/or meeting associated with the donor, among other examples). The contact list management system may perform the email operation based on the user input. As an example, the contact list management system may generate an email account associated with the user, and the contact list management system may cause an email to be sent to an email address associated with the donor using the email account associated with the user. The contact list management system may maintain an email message log that displays the altered email addresses associated with the donors. If the donor contributes to the user, then the contact list management system may display the email address associated with a donor that contributes rather than the altered email address associated with the donor that contributes.

In some implementations, the contact list management system may use a machine learning model to analyze the user information and/or the contact list data (e.g., to obtain the contact list information), as described in more detail elsewhere herein. For example, the machine learning model training and usage described herein may be performed using a machine learning system. The machine learning system may include, or may be included in a computing device, a server, a cloud computing environment, among other examples, such as the contact list management device described in more detail elsewhere herein.

In some implementations, the machine learning model may be trained using a set of observations. The set of observations may be obtained from training data (e.g., historical data), such as data gathered during one or more processes described herein. In some implementations, the machine learning system may receive the set of observations (e.g., as input) from the contact list management device, as described elsewhere herein.

The set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the contact list management device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of “previous contributions to candidate” (e.g., associated with donors who previously contributed to a candidate), a second feature of “previous contributions to endorsers” (e.g., associated with donors who previously contributed to endorsers of the candidate), a third feature of “Contribution amount threshold” (e.g., associated with a contribution amount threshold), and so on. For example, for a first observation, the first feature may have a value of “Yes” (e.g., the donor previously contributed to the candidate), the second feature may have a value of “Yes” (e.g., the donor previously contributed to endorsers of the candidate), and the third feature may have a value of “Satisfied” (e.g., the contribution amount threshold is satisfied), and so on. These features and feature values are provided as examples and may differ in other examples. For example, the feature set may include one or more features associated with the contact list data, as described in more detail elsewhere herein, among other examples.

In some implementations, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. As an example, the target variable may be “confidence score,” which may have a value of 98 for the first observation. In some implementations, the confidence score may be used to indicate a likelihood that the donor will contribute to the candidate, as described in more detail elsewhere herein.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As an example, the machine learning system may train a machine learning model using the set of observations and using one or more machine learning algorithms, such as a regression algorithm, a decision tree algorithm, a neural network algorithm, a k-nearest neighbor algorithm, and/or a support vector machine algorithm, among other examples. In some implementations, the machine learning model may be trained using historical events associated with the contact list information (e.g., as described in more detail elsewhere herein). After training, the machine learning system may store the machine learning model as a trained machine learning model to be used to analyze new observations.

In some implementations, the machine learning system may apply the trained machine learning model to a new observation, such as by receiving a new observation and inputting the new observation to the trained machine learning model. As shown, the new observation may include a first value of “No” (e.g., the donor has not previously contributed to the candidate) a second feature of “No” (e.g., the donor has not previously contributed to endorsers of the candidate, and a third value of “Not Satisfied” (e.g., the amount contribution threshold is not satisfied), and so on, as an example. The machine learning system may apply the trained machine learning model to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model may predict a value of 30 for the target variable of “Confidence Score” for the new observation. Based on this prediction, the machine learning system may cause a first automated action to be performed (e.g., by instructing another device to perform the automated action), among other examples. The first automated action may include, for example, causing the contact list management device to assign a low score to the donor associated with the new observation.

In some implementations, the trained machine learning model may classify (e.g., cluster) the new observation in a cluster. The observations within a cluster may have a threshold degree of similarity. As an example, if the machine learning system classifies the new observation in a first cluster (e.g., “Low Priority Donor”), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above. In some implementations, the automated action associated with the new observation may be based on a target variable value having a particular label (e.g., classification or categorization), may be based on whether a target variable value satisfies one or more thresholds and/or may be based on a cluster in which the new observation is classified.

In some implementations, the trained machine learning model may be re-trained using feedback information. For example, feedback may be provided to the machine learning model. The feedback may be associated with actions performed based on the recommendations provided by the trained machine learning model and/or automated actions performed, or caused, by the trained machine learning model. In other words, the recommendations and/or actions output by the trained machine learning model may be used as inputs to re-train the machine learning model (e.g., a feedback loop may be used to train and/or update the machine learning model).

In this way, the machine learning system may apply a rigorous and automated process in connection with enhanced contact list generation and tracking. The machine learning system may enable recognition and/or identification of tens, hundreds, thousands, or millions of features and/or feature values for tens, hundreds, thousands, or millions of observations, thereby increasing accuracy and consistency and reducing delay associated with generating and/or tracking a contact list via a contact list management device relative to requiring computing resources to be allocated for tens, hundreds, or thousands of operators to manually generate and/or track a contact list using the features or feature values.

FIG. 2 is a diagram of an example environment 200 in which systems and/or methods described herein may be implemented. As shown in FIG. 2, environment 200 may include a contact list management system 210, a user device 220, and a contact list database 230, and a network 240. Devices of environment 200 may interconnect via wired connections, wireless connections, or a combination of wired and wireless connections.

The contact list management system 210 may include one or more devices capable of receiving, generating, storing, processing, providing, and/or routing information associated with enhanced contact list generation and tracking, as described elsewhere herein. The contact list management system 210 may include a communication device and/or a computing device. For example, the contact list management system 210 may include a server, such as an application server, a client server, a web server, a database server, a host server, a proxy server, a virtual server (e.g., executing on computing hardware), or a server in a cloud computing system. In some implementations, the contact list management system 210 includes computing hardware used in a cloud computing environment.

The user device 220 may include one or more devices capable of receiving, generating, storing, processing, and/or providing information associated with enhanced contact list generation and tracking, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The contact list database 230 may include one or more devices capable of receiving, generating, storing, processing, and/or providing information associated with enhanced contact list generation and tracking, as described elsewhere herein. The contact list database 230 may include a communication device and/or a computing device. For example, the contact list database 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the contact list database 230 may store historical interaction data corresponding to historical interactions associated with the user, the donor, and/or the prospective donor, as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with enhanced contact list generation and tracking. The device 300 may correspond to the contact list management system 210, the user device 220, and/or the contact list database 230. In some implementations, the contact list management system 210, the user device 220, and/or the contact list database 230 may include one or more of the devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more of the processors 320, causes the one or more of the processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

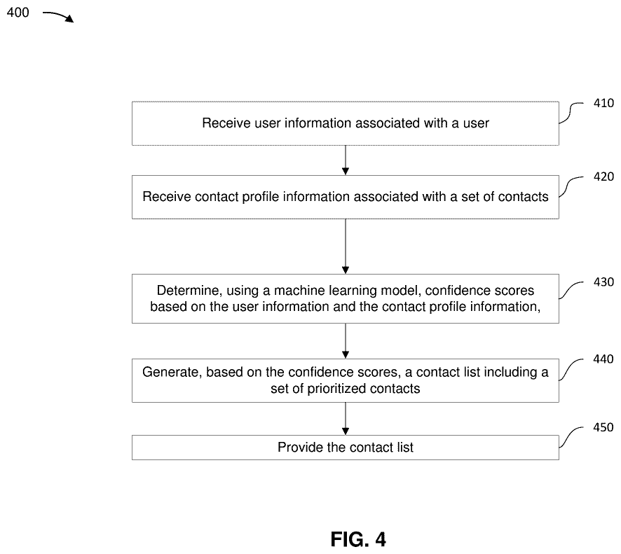

FIG. 4 is a flowchart of an example process 400 associated with enhanced contact list generation and tracking, in accordance with some embodiments of the present disclosure. In some implementations, one or more process blocks of FIG. 4 may be performed by the contact list management system 210. In some implementations, one or more process blocks of FIG. 4 may be performed by another device, or a group of devices, separate from or including the contact list management system 210. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, the process 400 includes receiving user information (e.g., candidate information) associated with a user (e.g., a candidate) (block 410).

As further shown in FIG. 4, the process 400 includes receiving contact profile information (e.g., donor profile information) associated with a set of contacts (e.g., a set of donors) (block 420).

As further shown in FIG. 4, the process 400 includes determining, using a machine learning model, confidence scores based on the user information and the contact profile information, wherein the confidence scores correspond to contacts included in the set of contacts, and wherein the confidence scores indicate a likelihood of a future contribution (e.g., a donation) to the user by the contacts included in the set of contacts (block 430).

As further shown in FIG. 4, the process 400 includes generating, based on the confidence scores, a contact list including a set of prioritized contacts (e.g., a set of prioritized donors) (block 440).

As further shown in FIG. 4, the process 400 includes providing the contact list (e.g., a donor list) (block 450).

In some implementations, the set of prioritized contacts may include at least one contact who previously contributed to the user and at least one contact who has not previously contributed to the user. In some implementations, the process 400 includes modifying the contact list based on at least one of a geographic location, a maximum donation level, or a minimum donation level related to a future user event (e.g., a future candidate event). In some implementations, the process 400 includes receiving a request to contact at least one prioritized contact included in the set of prioritized contacts and automatically contacting, by the contact list management system and based on the request, the at least one prioritized contact. The request to contact may be a request to contact via at least one of an electronic mail transmission, a short message service transmission, or a telecommunication. The contact list may include obfuscated contact information for the set of prioritized contacts. The contact profile information may include at least one of name information, demographic information, contribution history information, philanthropic activity information, business information, professional information, or political information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system, comprising:
one or more memories; and
one or more processors, communicatively coupled to the one or more memories, configured to:
receive user information associated with a user;
receive contact profile information associated with a set of contacts,
determine, using a machine learning model and based on the user information and the contact profile information, confidence scores corresponding to contacts included in the set of contacts,
wherein the confidence scores indicate a likelihood of a future contribution to the user by contacts included in the set of contacts;
generate, based on the confidence scores, a contact list including a set of prioritized contacts; and
provide the contact list.

2. The system of claim 1, wherein the set of prioritized contacts includes at least one contact who previously contributed to the user and at least one contact who has not previously contributed to the user.

3. The system of claim 1, wherein the one or more processors are further configured to:
modify the contact list based on at least one of a geographic location, a maximum donation level, or a minimum donation level related to a future user event.

4. The system of claim 1, wherein the one or more processors are further configured to:
receive a request to contact at least one prioritized contact included in the set of prioritized contacts; and
automatically contact, based on the request, the at least one prioritized contact.

5. The system of claim 4, wherein the request to contact is a request to contact via at least one of:
an electronic mail transmission,
a short message service transmission, or
a telecommunication.

6. The system of claim 1, wherein the contact list includes obfuscated contact information for the set of prioritized contacts.

7. The system of claim 1, wherein the contact profile information includes at least one of:
name information,
demographic information,
contribution history information,
philanthropic activity information,
business information,
professional information,
personal information, or
political information.

8. A method, comprising:
receiving, by a contact list management system, user information associated with a user;
receiving, by the contact list management system, contact profile information associated with a set of contacts,
determining, by the contact list management system and using a machine learning model, confidence scores based on the user information and the contact profile information,
wherein the confidence scores correspond to contacts included in the set of contacts, and
wherein the confidence scores indicate a likelihood of a future contribution to the user by the contacts included in the set of contacts;
generating, by the contact list management system and based on the confidence scores, a contact list including a set of prioritized contacts; and
providing, by the contact list management system, the contact list.

9. The method of claim 8, wherein the set of prioritized contacts includes at least one contact who previously contributed to the user and at least one contact who has not previously contributed to the user.

10. The method of claim 8, further comprising:
modifying, by the contact list management system, the contact list based on at least one of a geographic location, a maximum donation level, or a minimum donation level related to a future user event.

11. The method of claim 8, further comprising:
receiving, by the contact list management system, a request to contact at least one prioritized contact included in the set of prioritized contacts; and
automatically contacting, by the contact list management system and based on the request, the at least one prioritized contact.

12. The method of claim 11, wherein the request to contact is a request to contact via at least one of:
an electronic mail transmission,
a short message service transmission, or
a telecommunication.

13. The method of claim 8, wherein the contact list includes obfuscated contact information for the set of prioritized contacts.

14. The method of claim 8, wherein the contact profile information includes at least one of:
name information,
demographic information,
contribution history information,
philanthropic activity information,
business information,
professional information, or
political information.

15. A non-transitory computer-readable medium storing a set of instructions, the set of instructions comprising:
one or more instructions that, when executed by one or more processors of a contact list management system, cause the contact list management system to:
receive user information associated with a user;
receive contact profile information associated with a set of contacts,
determine, using a machine learning model and based on the user information and the contact profile information, confidence scores corresponding to contacts included in the set of contacts,
wherein the confidence scores indicate a likelihood of a future contribution to the user by contacts included in the set of contacts;
generate, based on the confidence scores, a contact list including a set of prioritized contacts; and
provide the contact list.

16. The non-transitory computer-readable medium of claim 15, wherein the set of prioritized contacts includes at least one contact who previously contributed to the user and at least one contact who has not previously contributed to the user.

17. The non-transitory computer-readable medium of claim 15, wherein the one or more instructions further cause the contact list management system to:
modify the contact list based on at least one of a geographic location, a maximum donation level, or a minimum donation level related to a future user event.

18. The non-transitory computer-readable medium of claim 15, wherein the one or more instructions further cause the contact list management system to:
receive a request to contact at least one prioritized contact included in the set of prioritized contacts; and
automatically contact, based on the request, the at least one prioritized contact.

19. The non-transitory computer-readable medium of claim 15, wherein the request is a request to contact via at least one of:
an electronic mail transmission,
a short message service transmission, or
a telecommunication.

20. The non-transitory computer-readable medium of claim 15, wherein the contact list includes obfuscated contact information for the set of prioritized contacts.
